(19) United States
(12) Patent Application Publication
(10) Pub. No.: US 2006/0112815 A1
(43) Pub. Date: Jun. 1, 2006

(54) Apparatus method for controlling MIDI velocity in response to a volume control setting

(75) Inventor: Mark Van Sant, Oregon House, CA (US)

Correspondence Address: JOHN P. O'BANION;O'BANION & RITCHEY LLP, 400 CAPITOL MALL SUITE 1550, SACRAMENTO, CA, 95814, US

(73) Assignee: BURGETT, INC.

(21) Appl. No.: 11/001,631

(22) Filed: Nov. 30, 2004

(51) Int. Cl. G10H 7/00

(52) U.S. Cl. 84/645

(57) ABSTRACT

A system and method of non-proportionally adjusting hammer velocity in a player piano according to received note velocity information (i.e. in a MIDI stream) in response to volume level settings. The adjustments to the hammer (actuator) velocity are performed non-proportionally. Thus, the overall hammer strike velocity is reduced according to the current volume setting while the velocity difference between hammer strikes is not scaled down proportional to the reduction. In one embodiment an additive method is utilized which adds an offset based on volume setting in relation to a mid-volume setting to the input note velocity to generate an output strike force value which modulates hammer actuation control power. Utilizing the inventive system and method, piano playback at low volume settings retains more “crispness” than is achieved utilizing proportionally scaled note velocity methods.

### CROSS-REFERENCE TO RELATED APPLICATIONS

Not Applicable

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to electronically controlled player pianos and similar automated electromechanical musical instrument devices, and more particularly to methods of scaling MIDI velocity parameters in response to low volume settings.

2. Description of Related Art

Accurate reproduction of the subtle nuances in a piano composition has long been a goal in the design of modern electronic player pianos. Great strides have been made toward that end by registering the hammer velocity within the recording and then controlling the actuator during playback so that the hammer velocity closely matches the recorded note velocity pattern. It is generally understood that the audio volume produced in response to a given key strike is directly related to the velocity at which the string is struck by the hammer associated with the key (note) in response to actuator activity.

Many of today's electronic player pianos are controlled using MIDI (Musical Instrument Digital Interface) sequences which provide a standardized form of representing notes and duration as well as key velocity factors.

It is important to be able to adjust the playback volume for the piano so that the player system may be comfortably listened to within smaller spaces at reduced volume levels, such as within a home setting. According to conventional design the note velocity information from the MIDI input is scaled in proportional to the volume control setting. For example the output is scaled according to: tableRow=MIDI_Input×volumeControl/64. The constant 64 provides a level that is at half of the maximum MIDI setting of 128 intensity levels (i.e. representing a “normal” listening level). The tableRow value is then used in determining, such as via a table lookup, the set of forces at which to play the particular key.

The sound generated by current player pianos in playback mode at low volume settings can provide acceptable sound quality, but is generally considered to provide a “muddy” response, that lacks desired “crispness”.

Therefore, a need exists to improve audio reproduction at low audio volume settings within electronically controlled acoustic player piano systems. The present invention fulfills that need as well as others and overcomes drawbacks of prior control solutions.

### BRIEF SUMMARY OF THE INVENTION

The present invention provides a method of adjusting MIDI (Musical Instrument Digital Interface) velocity parameters for driving hammer actuators on an instrument, such as an acoustic piano, in response to volume settings. It has not been generally appreciated in the industry that the lack of audio “crispness” in the player pianos at low volume settings can be largely overcome with the use of proper compensation techniques. The present invention describes a new system and method for achieving player piano operations at reduced volume settings while retaining desirable characteristics of renditions played at higher volume settings.

The system of the present invention provides non-proportional adjustment of the note velocity settings in response to the audio volume setting. The note velocity information may be contained for example within a MIDI stream that includes note number, note velocity, and note duration. The present invention provides adjustments to the hammer (actuator) velocity which are determined non-proportional to the relationship between the overall hammer strike velocity and the current volume setting. In this way the velocity difference between hammer strikes is not scaled down proportional to the overall reduction in strike velocity based on the volume setting.

By way of example and not limitation, the system and method incorporates an “additive” (or “subtractive”) method for determining the hammer velocity at which a note is to play. In particular, the invention provides novel adjustment of hammer velocity when the system volume is at a volume level below the “normal” volume settings. The present invention represents a beneficial departure from the conventional methods which simply scale the input based on the volume setting. Sound quality for low volume level piano playback according to the invention is significantly improved and audio output remains “crisp” without the “muddiness” which characterizes low audio volume settings when using conventional note velocity scaling approaches.

The method according to the present invention provides crisp distinctions between notes as it does not proportionally scale down the velocity differences between notes but instead non-proportionally adjusts the strike velocity setting, such as in one embodiment by an additive (or subtractive) method. It will be appreciated that the conventional note velocity adjustment (scaling) method is typically based on tableRow=MIDI_Input×volumeControl/64, or similar form of proportional scaling.

However, the present system and method provides improved volume adjustment based on non-proportional adjustments, by way of example according to: tableRow=MIDI_Input+(volumeControl−64), or similar non-proportional methods. It will be appreciated that this approach does not “scale” each velocity value in proportional to the volume control setting, as this would reduce the note-to-note velocity differences reducing the “crispness” of the playback. The present method improves dynamic range for acoustic pianos played at low volume settings, and is generally applicable to implementation on a number of musical instrument applications. It should be appreciated that the non-proportional adjustment approach described herein may be utilized by itself, or utilized in combination with proportionally scaled methods, or other note velocity control methods, without departing from the teachings of the present invention.

The invention preferably provides a velocity boundary control mechanism for controlling the output volume range to assure that proper audio outputs are produced across the entire range of note velocities and volume settings. By way of example, the boundaries can be implemented by clamping volume excursions to the boundaries of the range. Audio volumes which would drop below a desired threshold, or represent a negative volume, are thus clamped to a desired minimum volume level, such as to a low volume level that is just within the realm of hearing. The maximum volume can also be controlled to prevent excursions beyond the available volume range of the MIDI system or actuator hardware. One embodiment of the system allows the user to adjust the characteristics of boundary control, such as the level at which the minimum volume level is clamped.

The present invention may be implemented in a number of different embodiments. One embodiment describes an apparatus for controlling playback in an acoustic musical instrument in response to received note information, comprising: (a) an audio volume control for modulating the maximum audio playback intensity of an acoustical musical instrument; (b) means for determining an offset value by subtracting a given instrument volume setting from the registered volume setting; (c) means for summing the offset value with a note velocity received within the note information (i.e. as part of the MIDI stream containing at least note number, note velocity, and note duration), the values being summed to produce a strike force value; and (d) means for driving output actuators (i.e. hammers) of the instrument based on the strike force value. Preferably, a means for clamping the strike force value to a minimum velocity value in response to sufficiently low or negative values for the strike force value is incorporated, while a means for clamping the strike force value to a maximum velocity value to prevent the strike force value from exceeding the maximum velocity value can also be included. The strike force value can be utilized separately, or alternatively in combination with another form of strike force value computation (proportional or non-proportional) to provide a non-proportional strike force contribution which mitigates the scaling down of note velocity differences.

An embodiment of the invention may also be described as an apparatus for controlling playback in an acoustic musical instrument in response to received note information, comprising: (a) an audio volume control for modulating the audio playback intensity of an acoustical musical instrument; (b) a computer configured for registering the audio volume control setting and controlling actuators for each note within the musical instrument; and (c) programming configured for execution on the computer for, (i) receiving a stream of note information describing note number, note duration, and note velocity, for being played back on the musical instrument, (ii) determining an offset value by subtracting a given instrument volume setting from the registered volume setting, (iii) summing the offset value with note velocity received within the note information being received for playback of each note to generate a strike force value, (iv) communicating drive control signals to output actuators of the instrument in response to the strike force value. The programming may be provided within memory devices coupled to the computer, or on media from which the programming can be read by the computer (i.e. permanent or removable memory devices, magnetic media, optical media, floppy disks, programming downloads, and other means for conveying programming and/or data).

The acoustic instrument for which the strike velocity is controlled preferably comprises an acoustic piano or harpsichord configured with strings which are struck, plucked, or otherwise manipulated in response to the activity of said output actuators (hammer actuators) for producing notes during playback. However, the method is applicable to any musical instrument whose playback is driven by actuators controlled by an electrical control system. The note information received, such as including note velocity, is preferably defined within a musical data standard, such as the musical instrument digital interface (MIDI) standard.

The invention may also be embodied in terms of a method of controlling musical instrument note velocity in response to note playing information received by the musical instrument, comprising: (a) registering a volume setting for playback of a musical instrument; (b) determining a velocity offset value during playback in response to the volume setting; (c) receiving a note velocity value as input for a note to be played on the musical instrument; (d) generating a hammer velocity value as output in response to a non-proportional computation of the velocity offset value and the note velocity value (i.e. in response to adding the velocity offset value to the note velocity value); (e) controlling actuator velocity in response to the hammer velocity value; and (f) repeating steps (c) through (e) during a playback sequence.

Embodiments of the present invention can provide a number of beneficial aspects including but not necessarily limited to the following, which can be implemented either separately or in any desired combination without departing from the present teachings.

An aspect of the invention improves the “crispness” of acoustic audio playback within a player piano, or other player instrument, based on non-proportional note velocity adjustments responsive to the volume setting.

Another aspect of the invention is to provide non-proportional note velocity adjustment wherein the velocity difference between incoming notes is not scaled down in proportion to the volume setting in relation to the maximum note velocity.

Another aspect of the invention is to provide a note velocity adjustment mechanism that can be utilized separately, or in combination with other techniques.

Another aspect of the invention is to provide a non-proportional note velocity adjustment method that can be readily implemented.

Another aspect of the invention is to provide a non-proportional note velocity adjustment which is applicable to music representation standards, such as MIDI.

A still further aspect of the invention is that of providing a non-proportional note adjustment method that does not adversely impact playback quality at average to high playback volume settings.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a player piano playback control system including the additive process according to an aspect of the present invention for generating velocity in response to the volume setting.

FIG. 2 is a block diagram of a player piano playback control system of FIG. 1 which includes a limit control module according to an aspect of the present invention.

FIG. 3 is a flowchart of generating additive velocity control in response to volume setting according to an aspect of the present invention.

### DETAILED DESCRIPTION OF THE INVENTION

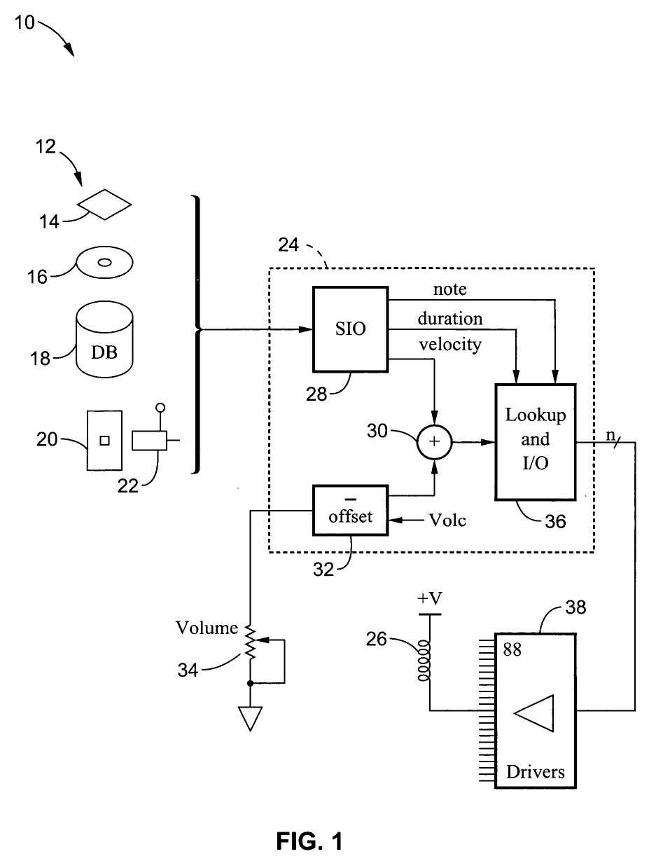

Referring more specifically to the drawings, for illustrative purposes the present invention is embodied in the apparatus and method generally shown in FIG. 1 through FIG. 3. It will be appreciated that the apparatus may vary as to configuration and as to details of the parts, and that the method may vary as to the specific steps and sequence, without departing from the basic concepts as disclosed herein.

The present invention recognizes problems with the existing player piano technology and seeks to overcome the “muddy” player piano output which arises at low volume settings. The system and method utilizes a non-scalar method of adjusting hammer velocity based on received note velocity adjusted for the current audio volume setting.

Before describing the details of the present invention we will detail how it is that conventional systems generate a somewhat flat, lifeless and muddy response when operated at low volume settings. It will be recognized that a conventional system scales down the received note velocities in proportion to the volume setting (i.e. volume setting in relation to mid-volume, max-volume or other fixed point in the volume range). This scaling provides the reduction of volume intensity, but has the unfortunate side effect of reducing the “crispness” of the music being played back, rendering it “lifeless” and “muddy”.

The following is an example which illustrates how scalar velocity control reduces playback “crispness”. Assume a key (note) received for playback has a MIDI velocity of 63 (out of 127) on a first hammer (key) strike and then a MIDI velocity of 53 on a subsequent hammer strike. First, considering a scenario in which the volume is set to a mid-volume setting of 64, the value of the first strike is given by:
tableRow=63×64/64=63
the resultant velocity value is then looked up in an expression table (or other computation or table based approach) and sent to the actuator driver. The next strike is similarly determined resulting in a strike value of 53. The nominal volume setting in this instance does not alter the strike settings and the difference between the key strikes is a value of 10.

Second, consider a scenario in which the audio volume of the instrument is turned down to a low volume, such as reduced from 64 in the previous scenario to a value of 20, while playing the same note sequence. In this case the value of the first strike at the low volume setting is given by:
tableRow=63×20/64=19.7
and the value of the second strike is given by:
tableRow=53×20/64=16.6
The velocity difference between the two key strikes has thus been reduced from 10 down to about 3. The difference now between the intensities of the two key strikes may not even be audible at the low audio volume setting. It should be appreciated that even lower volume settings can be utilized which will further compress keystroke velocity differences, wherein their respective volume intensity is less distinguishable such that the audio output sounds “muddy”.

According to the present invention the velocity differences between the keystroke velocities are better maintained using a non-proportional velocity adjustment, for example with tableRow being given by:
tableRow=MIDI_Input+(volumeControl−64)
It should be appreciated that this can also be similarly considered a “subtractive” method, such as given by:
tableRow=MIDI_Input−(64−volumeControl)
Furthermore, it should be appreciated that various similar mathematical relationships can be less preferably established to provide velocity adjustment which is not proportional to the relative volume setting.

In a purely additive (or subtractive) strike computation as shown, the differences in strike velocity between notes is fully maintained. In recomputing the prior scenarios according to this embodiment of the invention, the first keystroke volume is given by:
tableRow=63+(64−64)=63
while the second keystroke is given by:
tableRow=53+(64−64)=53
which maintains the difference of 10 at a normal volume setting. Now as the volume is reduced to the level of 20 the first keystroke velocity is given by:
tableRow=63+(20−64)=19
while the velocity of the second keystroke is now given by:
tableRow=53+(20−64)=9
wherein the tableRow difference between the first and second strike is maintained at a difference of 10, which maintains the crispness of the sound despite the lowered playback volume setting. It should be appreciated that these calculations can be readily performed, if desired, without the need of overhead intensive floating-point calculations, or other processor intensive computing steps.

FIG. 1 illustrates by way of example a playback control system which modifies the actuator outputs in response to the user selected volume setting. It should be appreciated that the diagram depicts only the core elements of the invention, wherein playback information is received and modified in response to the volume setting.

As shown in the figure, playback information such as MIDI sequence data, is received from a source 12. The MIDI source for example may comprise any media, such as memory device 14, removable media 16 (i.e. CD ROM, DVD, floppy disk, etc.), or fixed media 18 (i.e. disk drive, non-removable memory, etc.), or it may comprise a transmission medium over which the playback information is received, such as a wired connection 20 or wireless connection 22.

A controller 24 is shown configured for receiving and processing playback information from source 12 and driving actuators 26 for producing notes on the instrument which match the playback sequence. In a preferred embodiment controller 24 comprises one or more computer elements, such as a microcontroller, microprocessor, digital signal processor (DSP) or similar.

Blocks are shown within controller 24 as a representative example of the general functions being performed according to the present invention. The functions are depicted in a simplified form and numerous conventional and non-conventional aspects may be added without departing from the teachings of the present invention. It should also be appreciated by one of ordinary skill in the art that these elements represent generic functional aspects and not specific circuitry. The controller can be implemented with any desired mix of dedicated circuits and computational elements by one of ordinary skill in the art without departing from the teachings of the present invention.

By way of example, the playback information comprises a MIDI sequence which includes note as well as associated velocity and duration information for that note. A serial interface 28 is shown applying the MIDI velocity data to a summer 30 which adds the velocity data with offset data determined by offset element 32. The offset is preferably computed by subtracting a given audio volume value Vol_{C} from the current playback setting value Vol_{P} as established by volume selector 34. Audio volume selector 34 is depicted symbolically as a variable resistor (i.e. potentiometer with wiper shorted to one output), however, it should be appreciated that the volume setting may be established by any desired form of analog selector means (i.e. pots, sliders, switches, etc.), digital selector means (i.e. optical pots, position encoders, sensors, etc.), or programmatic means (i.e. volume input buttons, inputs displayed on a screen, microprocessor outputs, and so forth).

For example consider a volume selector 34 configured to provide a volume setting which ranges up to a value of 127 for full volume (i.e. range is 0 to 127). A mid-way volume, therefore, is set at a reference value Vol_{C} of 64, which is half of full scale volume. The reference volume is preferably set to between 25% to 75% of full volume, or more preferably around 50% of full volume. The offset is then determined within offset module 32 as Vol_Offset=Vol_{P}−Vol_{C}. In summer 30, Vol_Offset is added to the MIDI velocity (strike) value to produce a corrected strike value. The corrected strike value is then looked up along with the other MIDI parameters, such as in look-up and control programming 36 which outputs n control signals to actuator drivers 38 driving actuators 26, depicted as solenoid coils, directed for instance to driving the eighty-eight keys of a player piano instrument.

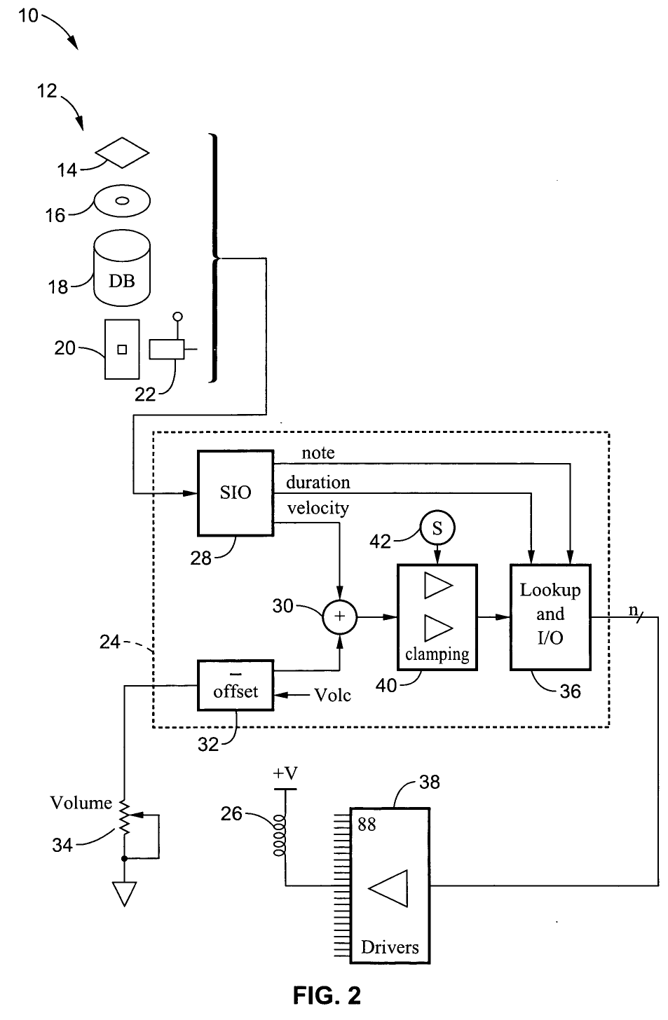

FIG. 2 illustrates another example embodiment 10 of note velocity adjustment circuitry which incorporates a boundary control means to assure that proper audio outputs are produced across the entire range of note velocities and volume settings. A boundary control means 40 is shown receiving the sum of the offset and received note velocity. By way of example the boundaries may be controlled by clamping them to prevent unwanted value excursions. An optional selector 42 is shown coupled to the boundary control means 40 to allow the user to control how, and/or to what levels, the boundaries are to be controlled. For example, embodiments of the invention can be configured to provide clamped boundaries, more complex transitional boundaries, or combinations thereof. The following describes an embodiment utilizing clamped boundary control.

The additive method of computing tableRow values according to the invention is subject to boundary conditions that the user may want corrected. These boundary problems do not show up in the conventional scaling method due to its proportional output. The first issue with non-proportional velocity adjustment is that the computed value from the additive method can become negative if the input playback value is low and is being played back at a sufficiently low volume setting. According to the above example with a volume setting of 20, if the input keystroke received is less than a value of 44, the resultant tableRow output would become negative. It should however, be appreciated that due to the mechanical nature of an acoustic instrument, such as an acoustic piano, extremely light key strikes at low volume settings are not audible, even when mechanically played. So ignoring the playback of these keys does not significantly detract from the audio playback experience. However, it is a simple matter to clamp the response to a desired minimum volume level which is set to allow all keystrokes to be heard.

A similar problem arises at the upper end of the volume scale, since the output sum could exceed the maximum allowable value of 127 for the MIDI stream. The upper end of volume can thus be similarly clamped to a desired maximum volume level setting. If the computation of forces are determined within the driver section, as described in another invention by the applicant, then the output sum need not be clamped in response to MIDI value limitations, but can be fully handled within the driver wherein the forces may be computed accurately with this minor restraint.

Although, the minimum volume level can be set for the system so that all notes will play, there may be instances in which the user is not concerned whether the notes can be heard and does not want to clamp the low end velocity at an audible level. The selector 42 represents a user settable control which the system uses to configure volume boundary characteristics.

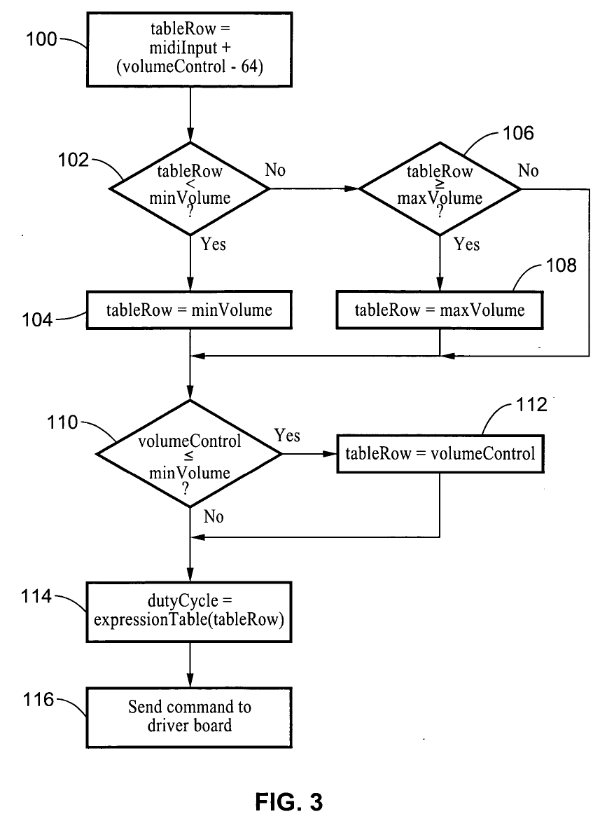

FIG. 3 illustrates an embodiment of a process for generating non-proportional key actuator outputs in response to player piano volume settings including the clamping of the minimum and maximum velocity values. Represented in block 100 is the process of offsetting the velocity in response to the volume setting, such as given by the following relation.
tableRow=MIDI_{—}Input+(volumeControl−64)
The portion (VolumeControl−64) generally corresponds to the offset element 32 shown in FIG. 1 and FIG. 2. It will be appreciated that Vol_{C} can be alternatively set to a different value, which is not necessarily the mid-volume setting (i.e. preferably within the range of from about 25% to 75% of maximum volume), and that the value of 64 depicted is in relation to the MIDI maximum volume setting of 127, wherein other maximum volume settings would be subject to different center volume settings Vol_{C}. If the use of the selected non-proportional velocity adjustment mechanism leads to boundary condition problems then a remedy should be provided, such as the described remedy which is based on clamping.

In block 102 a check is made to determine if the tableRow value is less than the minimum volume setting (minVolume). In response, the tableRow value is set to minVolume in block 104 to prevent erroneous tableRow values. A check is also performed at block 106 to determine if the tableRow value is above the maximum available volume setting (maxVolume), wherein tableRow is constrained in block 108 to maxVolume.

In an optional mode of the invention, the user can select to bypass the corrections to the minimum volume settings which assure that each note can be heard. By way of example, this mode can be selected when the user adjusts the volume control to a level below the minimum volume setting (minVolume). In support of that option, a determination is made as per block 110 on the relation between the volumeControl setting and the minimum available volume setting (minVolume). If volumeControl is less than minVolume then tableRow is set in accord with the volume control setting as per block 112. The duty cycle for actuation is then determined as per block 114, such as from an expression table, computation, or other available technique, responsive to the tableRow value. The resultant signal or data is then communicated as per block 116 to driver circuits for powering the key actuators.

It should also be appreciated that the non-proportional velocity adjustments performed in response to volume setting according to the present invention can be implemented utilizing computations which are not strictly additive or subtractive in nature, without departing from the teachings of the present invention. By way of example, tableRow can be computed and averaged with a portion (i.e. half) of the contribution received from a conventional process, such as a scalar computation as described in the background, and a portion (i.e. half) from the additive process. By way of example using a 50-50 split contribution: tableRow=(MIDI_Input×(volumeControl/128))+(MIDI_Input+(volumeControl−32)). In this case the velocity is still non-proportional and increases the audible expression of the different keystroke intensities even at low volume settings. The minimum and maximum boundaries are still preferably controlled, such as by clamping. The additive computation described may be similarly integrated with any other approaches to provide a hybrid mechanism that maintains a desired level of key velocity difference and thereby increases playback “crispness”.

Similar non-proportional mechanisms can be alternatively adopted in which other non-scalar mathematical mechanisms are utilized. By way of example logarithmic processing can be performed, such as by looking up in a log table the MIDI_Input setting and then applying the additive volume control component, which may be likewise looked up in a log table as desired. In some implementations of logarithmic non-proportional velocity determination, there would be no need for clamping as the curve can provide a desired transition to the minimum and maximum volume settings without flattening out the response as arises with a conventional proportional scaling mechanism.

Furthermore, it should be appreciated that the instrument can be configured to allow the user to select the mechanism, curve, or extent to which the velocity is adjusted in response to the volume setting. These controls can be provided as analog selector inputs, processor parameters, user configuration or by any other desired means. This would allow the user to select how they would like the instrument to react to changes in the volume setting.

The present invention describes systems and methods for determining hammer velocity in response to note velocity and audio in an acoustic instrument, in particular an acoustic piano, in response to audio volume setting. The technique provides a non-proportional output in response to changes in the input so that the differences between input note velocity values are retained non-proportionally to the relative volume setting, wherein playback audio “crispness” is increased. An embodiment of the non-proportional technique is described by way of example with an additive method which retains the full note velocity difference while additional hybrid approaches and similar non-proportional methods were described.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for controlling playback in an acoustic musical instrument in response to received note information, comprising:
an audio volume control for modulating audio playback intensity of an acoustic musical instrument within a volume setting range;
means for determining an offset value by subtracting a predefined instrument volume setting from a volume setting of said audio volume control;
means for summing said offset value with a note velocity received within note information, wherein the sum of said values represents a strike force value; and
means for driving output actuators of said instrument based on said strike force value.

2. An apparatus as recited in claim 1, further comprising means for clamping the strike force value to a minimum velocity value in response to a sufficiently low or negative value for said strike force value.

3. An apparatus as recited in claim 2, further comprising means for user control of velocity clamping.

4. An apparatus as recited in claim 1, further comprising means for clamping the strike force value to a maximum velocity value to prevent said strike force value from exceeding a maximum velocity value for the instrument.

5. An apparatus as recited in claim 1, further comprising means for utilizing said strike force value in combination with another form of strike force value computation to provide a non-proportional strike force contribution which mitigates the scaling down of note velocity differences.

6. An apparatus as recited in claim 5, wherein said strike force value is used in combination with a strike force value computed proportionally to the volume control setting.

7. An apparatus as recited in claim 1, wherein said means for determining an offset value and for summing, comprises:
a computer configured for receiving note information and for registering said volume control setting; and
programming executable on said computer for performing said subtracting and said summing.

8. An apparatus as recited in claim 1, wherein said acoustic instrument comprises an acoustic piano or harpsichord configured with strings which are manipulated in response to the activity of said output actuators.

9. An apparatus as recited in claim 1, wherein said predetermined volume setting comprises a constant predetermined volume value.

10. An apparatus as recited in claim 9, wherein said given instrument volume setting comprises a fixed proportion of the maximum volume level available for the instrument as selected within the range of approximately 25% to 75%.

11. An apparatus as recited in claim 9, wherein said given instrument volume setting comprises a proportion of about 50% of the maximum volume level available for the instrument.

12. An apparatus as recited in claim 10, wherein said given instrument volume setting comprises a volume value that can be established or modulated in response to user selection.

13. An apparatus as recited in claim 1, wherein said strike force value is utilized as an index for accessing an expression table containing force control information for the actuators.

14. An apparatus as recited in claim 1, wherein said note information providing said note velocity is defined within the musical instrument digital interface (MIDI) standard.

15. An apparatus for controlling playback in an acoustic musical instrument in response to received note information, comprising:
an audio volume control for modulating the audio playback intensity of an acoustic musical instrument;
a computer configured for registering one or more settings of the audio volume control and controlling actuators for playing notes of the musical instrument; and
programming configured for execution on said computer for,
receiving a stream of note information describing note number, note duration, and note velocity, for being played back on the musical instrument,
determining an offset value by subtracting a given instrument volume setting from said registered volume setting,
summing said offset value with note velocity received within the note information being received for playback of each note to generate a strike force value, and
communicating drive control signals to output actuators of said instrument in response to said strike force value.

16. An apparatus as recited in claim 15, wherein said acoustic instrument comprises an acoustic piano or harpsichord configured with strings which are manipulated in response to the activity of said output actuators for producing notes during playback.

17. An apparatus as recited in claim 15, wherein said strike force value is utilized for accessing an expression table containing force control information for said output to said actuators.

18. An apparatus as recited in claim 15, wherein said note information providing said note velocity is defined within the musical instrument digital interface (MIDI) standard.

19. An apparatus as recited in claim 15, wherein said programming is further configured for controlling the output volume range of the instrument by modifying the strike force value.

20. An apparatus as recited in claim 19, wherein said programming is configured for clamping the strike force value to a minimum velocity value in response to sufficiently low or negative values for said strike force value.

21. An apparatus as recited in claim 20, wherein said programming is further configured for modulating minimum velocity clamping in response to user input.

22. An apparatus as recited in claim 19, wherein said programming is configured for clamping the strike force value to a maximum velocity value to prevent said strike force value from exceeding the maximum velocity value for the instrument.

23. An apparatus as recited in claim 15, wherein said programming is further configured for combining said strike force value with another form of strike force value computation to provide a non-proportional strike force contribution which mitigates the scaling down of note velocity differences.

24. An apparatus as recited in claim 15, wherein said strike force value is utilized for controlling access to an expression table containing force control information for said actuators.

25. An apparatus as recited in claim 15, wherein said given instrument volume setting comprises a predetermined volume value set within the range of from approximately 25% to 75% of maximum volume within the instrument.

26. A method of controlling musical instrument note velocity in response to note playing information received by the musical instrument, comprising:
(a) registering a volume setting for playback of a musical instrument;
(b) determining a velocity offset value during playback in response to the volume setting;
(c) receiving a note velocity value as input for a note to be played on the musical instrument;
(d) generating a hammer velocity value as output in response to a non-proportional computation of said velocity offset value and said note velocity value;
(e) controlling actuator velocity in response to said hammer velocity value; and
(f) repeating steps (c) through (e) during a playback sequence.

27. A method of controlling musical instrument note velocity in response to note playing information received by the musical instrument, comprising:
(a) registering a volume setting for playback of a musical instrument;
(b) maintaining a velocity offset value during playback as the difference between said volume setting and a predetermined instrument volume setting;
(c) receiving a note velocity value as input for a note to be played on the musical instrument;
(d) generating a hammer velocity value as output in response to adding said velocity offset value to said note velocity value;
(e) retrieving or computing hammer force control information for controlling the velocity of note hammers being actuated in response to said hammer velocity value; and
(f) repeating steps (c) through (e) during a playback sequence.

28. A method as recited in claim 27, wherein steps (a) and (b) are repeated during playback in response to any changes in the volume setting of the instrument.
